(19) United States
(12) Patent Application Publication
(10) Pub. No.: US 2026/0085682 A1
(43) Pub. Date: Mar. 26, 2026

(54) PUMP OR MOTOR MOUNTING FLANGE

(71) Applicant: Caterpillar Inc., Peoria, IL (US)

(72) Inventor: Todd M. Jennings, Ramsey, MN (US)

(73) Assignee: Caterpillar Inc., Peoria, IL (US)

(21) Appl. No.: 18/897,438

(22) Filed: Sep. 26, 2024

(51) Int. Cl. F04B 53/16; F04B 1/2064

(52) U.S. Cl. CPC F04B 53/16; F04B 1/2064

(57) ABSTRACT

A pump/motor and flange may include a housing with a longitudinal centerline, a drive-level bore and an idler-level bore. The drive-level bore and the idler-level bore may be equally spaced away from the longitudinal centerline. The drive-level bore may be spaced apart from the idler-level bore by a pump/motor gauge distance. The pump/motor may also include a drive shaft having a longitudinal axis parallel to and offset from the longitudinal centerline of the housing. A flange may be provided having a drive shaft opening configured to receive the drive shaft. The flange may also include a first mounting hole spaced downward from the drive shaft opening by a first distance equal to ½ the pump gauge distance plus the offset distance. The flange may also include a second mounting hole spaced upward from the drive shaft opening by a second distance equal to the first distance.

### TECHNOLOGICAL FIELD

The present application relates generally to fluid management systems for work machines. More particularly, the present application relates to connections of pumps or motors within a fluid management system, such as a hydraulic system, to motors, engines, or other power take-off equipment or devices.

### BACKGROUND

Connections between pumps and motors may be subject to continual operational forces. For example, a motor or engine may include a rotating shaft that extends out of the motor/engine housing and into the pump to drive the pump. That is, the rotating shaft may pass through the connection and the pump may resist motion of the shaft creating a torque between the motor/engine and the pump. Moreover, the pump may be mounted to the motor/engine housing or other power take-off housing and, in some cases, may not be otherwise supported. Accordingly, the inertial or other forces from internal motions and pressures within the pump and between the pump and other equipment and/or any external forces acting on the pump from connections or other piping or systems may be imparted to the connection between the pump and the motor or other power take-off system. While a pump has been described, sometimes the fluid flow may be reversed and the motive force may be the flowing fluid flowing into a motor to drive the motor, which, in turn, may drive a drive shaft and provide rotational power to the device it is connected to. In either case (i.e., pump or motor), it remains that the connection between the pump/motor and the housing may resist the forces generated by the pump/motor.

Current flange designs for pumps and motors suffer from various drawbacks. For example, SAE A connections provide for only 2 bolts, which limits their torque capacity. In addition, the bolt locations on these flanges are on either side of the flange (i.e., as opposed to in the corners) and, as such, the bolts for these flanges can interfere with fluid connections of side-ported pumps or motors. In some cases, the bolt hole locations provided by an SAE A flange do not fit within the boundary of the mounting location (e.g., vibe pod). Rectangular European flanges extend beyond the boundary of many mounting locations preventing use of all of the bolt holes, potentially preventing mounting at all, and creating the potential for interference with surrounding devices or equipment.

### SUMMARY

In one or more examples, a pump/motor and flange for mounting the pump/motor at a mounting location may include a pump/motor including a housing defining a connection end and a free end and defining a cavity containing operable components of the pump/motor. The housing may have a longitudinal centerline and include a drive-level bore and an idler-level bore. Each of the drive-level bore and the idler-level bore may be adapted to receive a fastener, may be equally spaced, in opposite directions, away from the longitudinal centerline, and may extend parallel to the longitudinal centerline. The drive-level bore may be spaced apart from the idler-level bore by a pump/motor gauge distance. The pump/motor may also include a drive shaft extending from within the cavity out of the free end of the housing. The drive shaft may have a longitudinal or Z-axis parallel to the longitudinal centerline of the housing and may be offset from the longitudinal centerline by an offset distance measured in a direction extending toward the drive-level bore and parallel to a Y-axis that is perpendicular to the Z-axis. A flange may be provided having a mounting surface and a pump/motor surface and including a drive shaft opening configured to receive the drive shaft. The flange may include a first mounting hole for securing the flange to the mounting location. The first mounting hole may be spaced downward from the drive shaft opening by a first distance parallel to the Y-axis and equal to ½ the pump gauge distance plus the offset distance. The flange may also include a second mounting hole for securing the flange to the mounting location. The second mounting hole may be spaced upward from the drive shaft opening by a second distance equal to the first distance.

In one or more examples, a pump/motor and flange for mounting the pump/motor at a mounting location may include a pump/motor having a housing defining a free end and a connection end defining a connection footprint. The pump/motor may have a drive shaft that extends out of the connection end and is offset from a centerline of the pump/motor. The pump/motor and flange may also include a flange having a mounting surface and a pump/motor surface. The flange may also include a drive shaft opening generally centered on the flange and configured to receive the drive shaft such that the connection footprint of the pump/motor is offset from a centered position on the pump/motor surface. The flange may include a first mounting hole for securing the flange to the mounting location that is arranged within the connection footprint. The flange may also include a second mounting hole for securing the flange to the mounting location that is arranged outside the connection footprint.

In one or more other examples, a flange may be provided for mounting a pump/motor to a mounting location where the pump/motor has a longitudinal centerline and includes a first bore and a second bore for receiving fasteners. The first and second bore may be parallel to the longitudinal centerline, equally spaced, in opposite directions, away from a longitudinal centerline, and spaced from one another by a pump/motor gauge distance. The pump/motor may also have a drive shaft parallel to and offset from the longitudinal centerline by an offset distance. The flange may include a body comprising a generally plate-like element having a mounting surface and an opposing pump/motor surface. The flange may also include a drive shaft receiving opening extending through the body and defining a relative position for mounting the pump/motor to the flange. The flange may also include a first mounting hole for securing the flange to the mounting location. The first mounting hole being spaced downward from the drive shaft opening by a first distance equal to ½ the pump/motor gauge distance plus the offset distance. The flange may also include a second mounting hole for securing the flange to the mounting location. The second mounting hole may be spaced upward from the drive shaft opening by a second distance equal to the first distance.

### DESCRIPTION OF THE DRAWINGS

FIG. 1 is a perspective view of a work machine having a pump or motor with a mounting flange, according to one or more examples.

FIG. 2A is a perspective view of the pump or motor with the mounting flange mounted to a generally circular mounting plate, according to one or more examples.

FIG. 2B is a perspective view of the pump or motor with the mounting flange mounted to an irregularly shaped power take off adapter, according to one or more examples.

FIG. 2C is a perspective view of the pump or motor with the mounting flange mounted to a casting vibe system, according to one or more examples.

FIG. 3 is a cross-sectional exploded view of a mounting location, the mounting flange, and the pump or motor, according to one or more examples.

FIG. 4 is a perspective view of the pump/motor and flange, according to one or more examples.

FIG. 5A is a rear perspective view of the flange, according to one or more examples.

FIG. 5B is a front perspective view of the flange, according to one or more examples.

FIG. 6A is a front view of the pump/motor and flange, according to one or more examples.

FIG. 6B is a cross-sectional view through a pilot projection of the flange engaging a mounting location, according to one or more examples.

### DETAILED DESCRIPTION

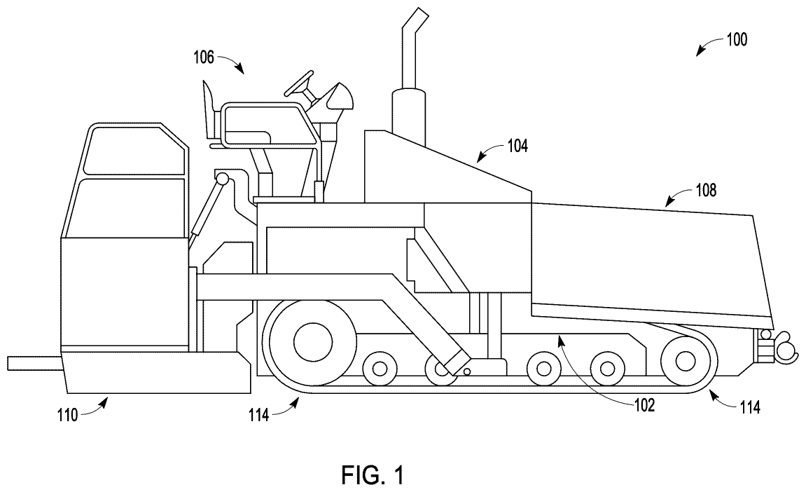

FIG. 1 is a front and side perspective view of a work machine 100 in the form of an asphalt paver. The work machine 100 may include a support frame 102 and a prime mover 104 arranged on the support frame 102 in addition to a cab or operator station 106. The work machine 100 may also include an intake bed 108 for receiving asphalt from a haul truck, an internal conveyance system for delivering the asphalt from the intake bed 108 to a ground surface below, and a trailing screed 110. The intake bed 108, conveyance system, and screed 110 may be coupled to and supported by the support frame 102. The work machine 100 may also include a ground engaging traction system such as one or more wheel and tire assemblies 114. Still other features of the work machine 100 may be provided and while a paving machine has been provided as an example, still other types of work machines 100 with a pump/motor mounting flange according to the present application may be provided. For example, a work machine 100 may include an excavator, crawler, front-end loader, compactor, rotary mixer, cold planer, haul truck, or another type of work machine 100.

The work machine 100 may include a hydraulic system operably coupled to the prime mover 104 to provide power to the hydraulic system and/or the hydraulic system may provide fluid flow to provide motor power to one or more aspects of the work machine. The presently described mounting flange may be provided to operably couple a pump/motor of the hydraulic system to a shaft or other power take-off or delivery point on work machine. In one or more examples, the hydraulic system may be used to operate one or more implements on the work machine 100. For example, with the asphalt paver shown, the hydraulic system may be used to drive one or more augers or other conveyance systems that may transport asphalt from the intake bed 108 to the ground below the paver. In the case of other work machines 100, other implements may be operated using a hydraulic system.

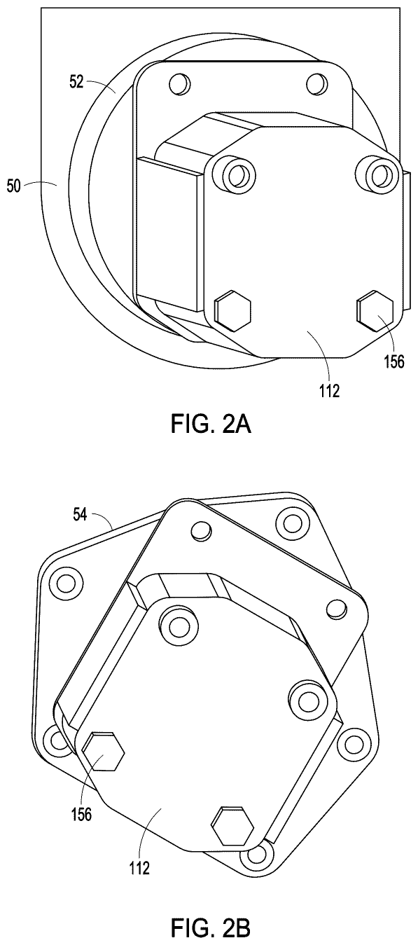

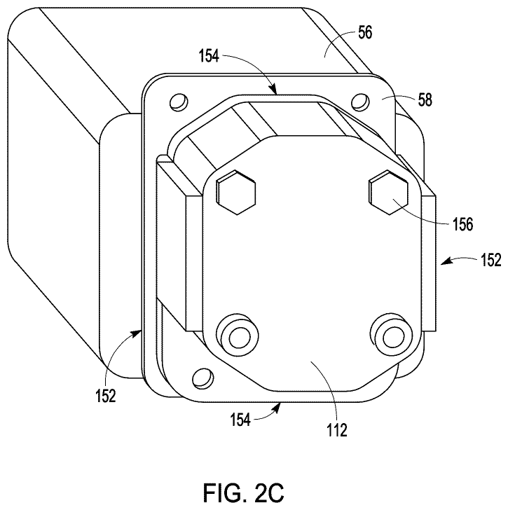

Referring now to FIG. 2A-2C, several examples of a connection between a hydraulic pump/motor 112 and a prime mover 104 or other power take off or delivery location are shown. For example, FIG. 2A shows the pump/motor 112 mounted on another pump/motor 50 having a generally circular mounting location 52. FIG. 2B shows the pump/motor 112 mounted on a power take off adapter having a generally irregularly shaped mounting location 54. FIG. 2C shows the pump/motor 112 mounted to a casting vibe system 56 having a generally rectangular mounting location 58. With respect to at least FIGS. 2A and 2B, given the offset (i.e., not centered) location of the power take off shaft extending from the pump/motor 112, the size of the pump/motor 112, and the geometry of the pump/motor 112, the mounting locations do not provide for attachment beyond at least one side of the pump/motor housing. That is, in both FIGS. 2A and 2B, for example, the pump/motor size and geometry causes the housing of the pump/motor 112 to generally align with a bottom edge of the mounting location 52/54, which does not leave room for bolted connections beyond a bottom side of the pump/motor 112. While FIG. 2C may allow for bolted connections above and below the pump/motor housing (i.e., were the flange to extend upward to reach the upper bolt holes), such a flange design would not accommodate situations such as that of 2A and 2B. As shown, the present flange design accommodates all of these situations without extending beyond the boundary of any of the mounting locations 52, 54, and 58. Moreover, as discussed in more detail below, the present flange design allows for more than 2 securing bolts as would be provided by, for example, a standard SAE A type flange.

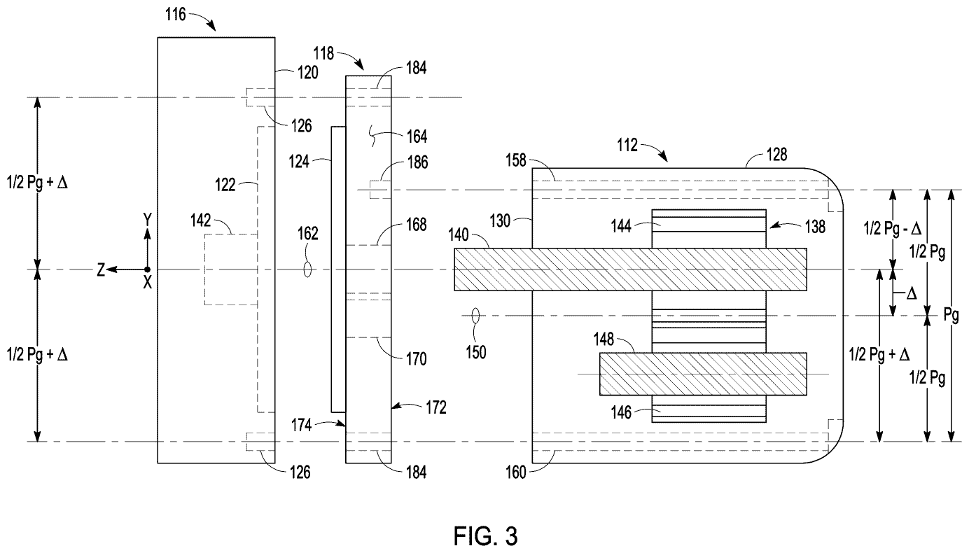

Turning now to FIG. 3, an exploded cross-sectional view of the mounting location 116, flange 118, and pump/motor 112, are shown. The mounting location 116 may include a generally flat mounting surface 120 having a pilot recess 122 sized and shaped to receive a pilot projection 124 on the mounting flange 118. The pilot projection 124 and the pilot recess 122 can also be reversed such that the pilot projection 124 is on the mounting location 120 and the recess 122 is on the flange 118. The mounting location 116 may also include bores 126 for receiving bolts to fasten the flange 118 to the mounting location 116. For example, the bores 126 may include tapped bores sized and located to align with bores through the flange 118 such that bolts may be inserted through the flange 118 to secure the flange 118 to the mounting location 116.

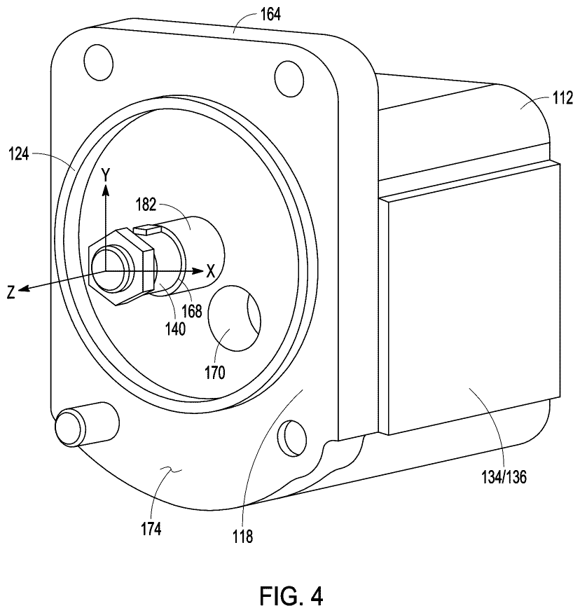

The pump/motor 112 may be configured to receive rotational power from the prime mover or other power take off device or system and supply fluid to a hydraulic system or other system on the work machine 100. Alternatively, the pump/motor 112 may be configured to receive fluid flow to generate rotation and deliver rotational power via a drive shaft to connected equipment. The pump/motor 112 may include a housing 128 having a connection end 130 configured for interfacing with and/or connection to the flange 118 and may define a connection footprint. The housing 128 may also include a free end 132 opposite the connection end 130 and the housing 128 may also include an input port 134 and an output port 136 (shown in FIG. 4 on a same side of the pump/motor and depending on the direction of rotation of the gears in the pump/motor). The housing 112 may define a cavity 138 configured to contain operable pump/motor components such as gears or other pump/motor components. The cavity 138 may also be configured to place those components in fluid communication with the input port 134 and the output port 136. In the case of a pump, the operable pump/motor components may be configured to draw fluid in through the inlet/outlet port 134 and eject fluid out through the inlet/outlet port 136. In the case of a motor, the operable pump/motor components may be configured to receive fluid in through the inlet/outlet port 136 and release fluid out through the inlet/outlet port 134. The pump/motor 112 may include a drive shaft 140 extending from the connection end 130 adapted to receive rotational power from the prime mover or other power take off device and deliver that rotational power to the pump components arranged in the cavity 138 or vice versa. In one or more examples, the drive shaft 140 may extend beyond the connection end 130 of the pump/motor 112 and may be supported at the surface of the housing by a bearing and/or seal. The drive shaft 140 may also extend through the flange 118, and into the mounting location 116 where it may engage a receiving component 142 adapted to impart/receive rotational motion on/from the drive shaft 140. For example, the drive shaft 140 may include a splined, keyed, or other feature on its end for rotationally engaging the receiving component 142.

In one or more examples, the pump/motor 112 may include a gear pump/motor. That is, with continued reference to FIG. 3, the gear pump/motor may include a pair of internal intermeshing gears arranged in the cavity 138 that cooperate in their rotation to draw in fluid from one side and eject fluid out the other side or, in the case of a motor, receive fluid in one side and release fluid out the other side. The inlet/outlet port 134 and the inlet/outlet port 136 may be arranged on opposing sides of the cavity 138 to take in and eject fluid, respectively. In one or more examples, the inlet/outlet ports 134/136 may be arranged on orthogonal sides or other sides rather than opposite sides where, for example, internal conduits route the fluid into and/or out of the cavity. In one or more examples, the gear pump/motor may include a drive gear 144 supported and driven by the drive shaft 140 and a follower gear 146 supported on an idler shaft 148. In the case of a pump, the follower gear 146 may receive power by meshing with the drive gear 144. In the case of a motor, both the drive gear 144 and the follower gear may receive power from the flowing fluid. Each of the drive shaft 140 and the idler shaft 148 may be supported by bearings that allow for generally free rotation of the shafts and the gears arranged thereon. The pair of gears may be generally centered in the pump housing causing the drive shaft 140 and the idler shaft 148 to be offset from a longitudinal centerline 150 of the pump housing 128. When viewed from the side, the portion of the pump above the centerline 150 may be deemed the drive level and the portion of the pump below the centerline 150 may be deemed the idler level.

As shown in FIG. 2C, the pump/motor 112 may be a generally four-sided pump/motor having two parallel and substantially straight sides 152 and two curved sides 154. In one or more examples, the pump/motor 112 may be a group 2 type pump/motor. In one or more examples, the pump/motor may be a group 1 or group 3 pump/motor. The pump/motor 112 may have a width measured across the housing 128 from a first straight side 152 to a second straight side 152 that ranges from approximately 75 mm to approximately 100 mm or from approximately 85 mm to approximately 90 mm or a width of approximately 86 to 88 mm or a width of approximately 87 mm may be provided.

In one or more examples as shown in FIGS. 2A-2C and in FIG. 3, the pump/motor 112 may be provided with one or more assembly bolts 156. The assembly bolts 156 may function to hold or secure one or more portions of the housing 128 together. One or more of the assembly bolts 156 may also be used to secure the pump/motor 112 to the flange 118. The assembly bolts 156 may extend into and/or through assembly bolt bores in the housing 128 that extend from the free end 132 of the pump/motor to the connection end 130. Where the assembly bolts 156 are to be used to secure the pump/motor to the flange 118, the bolts 156 may extend beyond the connection end 130 of the housing 128. For purposes of assembly, the manufacturer may provide a washer and a nut on the bolts that extend beyond the connection end 130 of the pump/motor 112 to allow the pump/motor 112 to be fully assembled and secured. When the pump/motor 112 is later attached to the flange 118, the washer and nut may be removed and the bolt 156 may be used to secure the pump/motor 112 to the flange 118.

In one or more examples, the pump/motor 112 may include one, two, three, four, or more assembly bores for receiving assembly bolts, or mounting bolts, as the case may be. In one example, the pump/motor 112 may include one or more assembly bores extending parallel to and generally adjacent to or on a drive shaft level of the pump/motor. That is, as shown in FIG. 3, the upper assembly bore or bores may be deemed drive-level bores 158. The pump/motor 112 may also include one or more assembly bores extending parallel to and generally adjacent to or on an idler shaft level of the pump/motor 112. That is, as shown in FIG. 3, the lower assembly bore or bores may be deemed idler-level bores 160.

By way of reference and as shown in FIGS. 3 and 4, the longitudinal axis of the drive shaft may define a Z-axis. A Y-axis may extend orthogonally to the Z-axis in an up/down direction and an X-axis may extend orthogonally to the Z-axis and the Y-axis in a side-to-side direction. The drive-level bores 158 and the idler-level bores 160 may be generally equally spaced away from a centerline of the pump/motor where the spacing is measured along the Y-axis (e.g., up down on the page of FIG. 3). Where multiple drive-level bores 158 and idler-level bores 160 are provided, the bores may also be equally spaced across the pump/motor along the X-axis (e.g., in/out of the page of FIG. 3). With continued reference to FIG. 3, the pump/motor 112 may have a bolt spacing or gauge measured along the Y-axis. For purposes of discussion, this dimension is called a pump/motor gauge (P_{g}). Since the drive-level bores 158 and the idler-level bores 160 are equidistant from the centerline 150 of the pump/motor 112, the distance from the centerline 150 to each bore is ½P_{g}. As noted above, given the geometry of the pump/motor 112, the drive shaft 140 is offset from the centerline 150 of the pump/motor by an offset distance (Δ). As such, the distance from the longitudinal axis 162 of the drive shaft 140 to the drive-level bores 158 may be ½P_{g}−Δ and the distance from the longitudinal axis 162 of the drive shaft to the idler-level bores 160 may be ½P_{g}+Δ.

While the pump/motor 112 has been described as a gear pump/motor, still other pumps/motors may be provided. In particular, where a positive displacement pump/motor is desired, a progressive cavity pump/motor, a piston pump/motor, a plunger pump/motor, or another positive displacement pump/motor may be provided. Moreover, a non-positive displacement pump/motor may also be provided such as centrifugal, multi-stage, or axial pumps/motors. In some examples, multiple pumps/motors may be provided that rely on a single mounting flange as described, herein. For example, a second pump/motor may be mounted to the free end of the pump described herein. Alternatively or additionally, the mounting location described herein may be a mounting location on another pump/motor where, for example, the drive shaft of the other pump/motor delivers the power to the present pump/motor or vice versa. Still other types of single and/or tandem pump/motor configurations may be provided.

Turning now to FIG. 4, a perspective view of the pump/motor 112 with the flange 118 is shown. The flange 118 may be configured to connect the pump/motor 112 to the mounting location 116 (see FIG. 3). In particular, the flange 118 may be adapted for bolting to the pump/motor 112 and for bolting to the mounting location 116 to secure the pump/motor 112 to the mounting location 116. The flange 118 may be adapted to fit within the boundary of the mounting location 116 and to transfer torque associated with the transfer of rotational power from the mounting location 116 to the pump/motor 112 or vice versa. In one or more examples, the flange 118 may include a body portion 164, a pilot projection 124, a drive shaft opening 168, a fluid passage opening 170, and a plurality of fastener receiving openings.

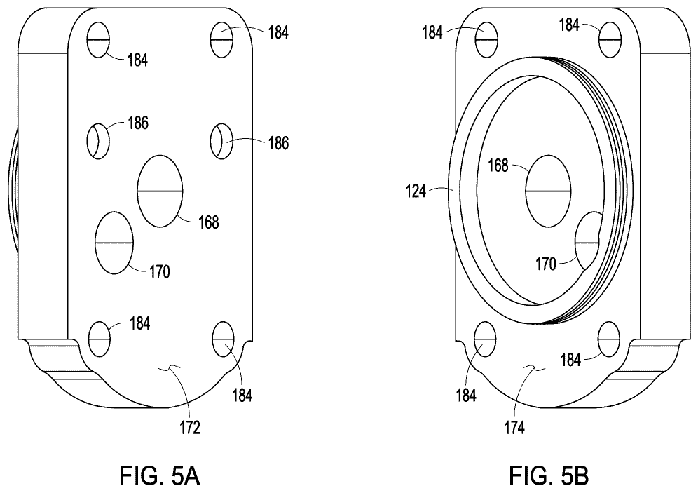

The body portion 164 of the flange 118 may be configured to provide an attachment surface for mounting the pump/motor and may also be configured for securing the pump/motor and the flange to the mounting location 116. The body 164 may be generally plate like with a pump/motor surface 172 (see FIG. 5A) and an opposing mounting surface 174, where the pilot projection 124 extends from the mounting surface 174. The body portion 164 may be sized to receive the pump/motor 112 against the pump surface 172 such that generally the entire footprint of the housing 128 of the pump/motor 112 fits within the boundary of the pump/motor surface 172. That is, as shown in FIG. 4, and except for some input/output port projections, the housing footprint is within the boundary of the pump/motor surface 172 of the flange 118. The flange 118 may extend beyond the footprint of the housing 128 in one or more directions. In the present example, the flange extends beyond the housing footprint in a single direction while the remaining 3 sides of the flange are generally aligned with the outer boundary of the housing. In some cases, the edges of the body 164 may follow the outer contours of the housing 128 on these 3 sides or, alternatively, the edges of the body 164 may more generally follow the space boundaries of the housing 128.

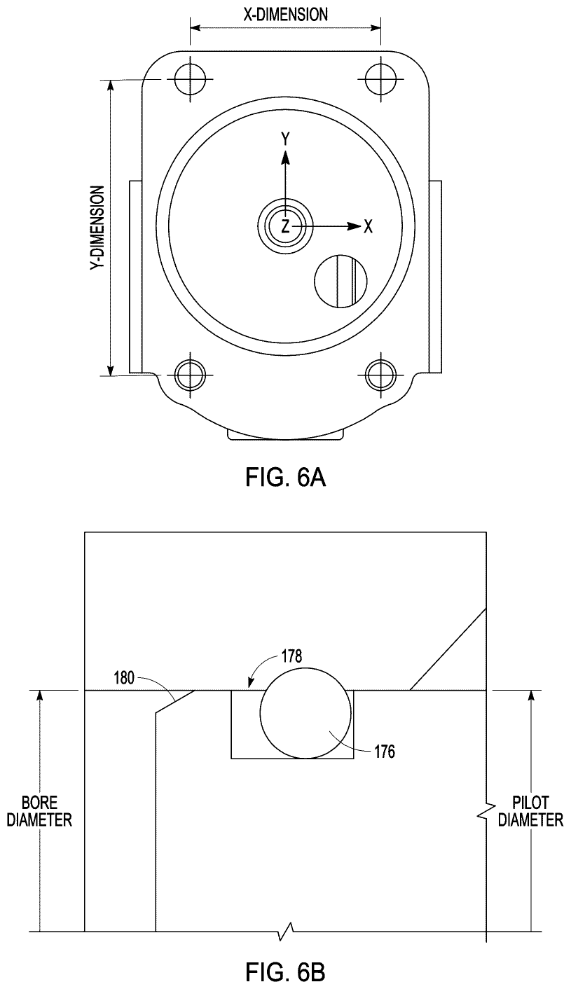

The pilot projection 124 may extend from the mounting surface 174 of the flange 118 (e.g., opposite the pump/motor surface 172) and may be adapted to engage a recess 122 on the mounting location 116. The pilot projection 124 may be a generally annular projection extending from the mounting surface 174 to a free end. The pilot projection 124 may have a center point arranged at or near the longitudinal axis 162 of the drive shaft 140 (e.g., on the Z-axis). The pilot projection 124 may have a rectangular cross-section and, in some examples, the projection 124 may be adapted to receive an O-ring 176. That is, in one or more examples, an O-ring groove 178 may extend into an outboard side of the pilot projection 124 and extend around the full perimeter of the pilot projection 124. As shown in FIG. 6B, the O-ring groove 178 may be spaced away from the free end of the pilot projection allowing for a chamfer 180 on the free end, such as a 30-degree chamfer measured at an angle to the longitudinal axis 162 of the drive shaft 140 of the pump 112, for example. An additional offset distance of approximately 0.5 mm to 2 mm or approximately 0.75 mm to 1.25 mm or approximately 1 mm may be provided between the chamfer 180 and the O-ring groove 178. While the pilot projection 124 is shown as annular, a full circular pilot projection 124 may also be provided. In one or more examples, the pilot projection 124 may have a diameter ranging from approximately 60 mm to approximately 100 mm or from approximately 70 mm to approximately 90 mm or a diameter of 80-85 mm or 81.5 mm or 83 mm may be provided. With these pilot dimensions it is noted that the ratio of the pilot projection diameter to the width of the pump may range from approximately 0.6 to 1.1 or from 0.8 to 1.0 or a ratio of approximately 0.9, 0.91, 0.92, 0.93, 0.94, 0.95, 0.96, 0.97, or 0.98 may be provided. It is to be appreciated that a larger pilot projection diameter can help facilitate a more stable connection and can also help facilitate a larger area within the mounting location for accessing and/or replacing a bearing, for example.

The drive shaft opening 168 may be arranged generally at or near the center of the flange 118. In particular, the drive shaft opening 168 may be arranged at the center of the pilot projection 124 and may be sized to allow the drive shaft 140 of the pump/motor 112 to pass through the flange 118. In one or more examples, a seal may be provided as the drive shaft 140 passes through the flange 118, a bushing may be provided, or the opening 168 may be sized to provide clearance around the drive shaft 140. In one or more examples, as shown in FIG. 4, a collar 182 may be provided extending out of the mounting surface 174 of the flange 118 that sleevably engages the drive shaft 140.

The fluid passage opening 170 may be an opening that extends fully through the flange 118 and is arranged within the boundary of the pilot projection 124. The fluid passage opening 170 may be configured to provide for a suction port extending through the mounting flange 118. In one or more examples, this suction port may be particularly suitable when the a pump is used in tandem with, for example, a piston unit to provide for a better suction oil condition.

With reference now to FIGS. 3, 4, and 5A-5B, one or more of the plurality of fastener receiving openings may be mounting holes 184 that extend fully through the flange 118 from the pump/motor surface to the mounting surface and may be adapted to receive fasteners to secure the flange 118 to the mounting location 116. In one or more examples, these through openings may be blank (e.g., unthreaded) openings adapted to receive shoulder bolts to draw the flange 118 against the mounting location 116 when the fasteners are inserted into threaded holes (e.g., bores 126) in the mounting location 116. In some cases, one or more of the mounting holes 184 may function to secure the pump/motor 112 to the flange 118 without securing the flange 118 to the mounting location 116. In these cases, the mounting holes 184 may be threaded. In addition, in these cases, the hole may be a blind hole rather than a through opening as shown in FIG. 3, where one of the bottom holes 184 in the flange 118 extends through the flange 118 and the other does not. As shown in FIGS. 3, 4, and 6A, one or more of the mounting holes 184 may be aligned with the idler-level bores 160 of the pump/motor and one or more of the mounting holes 184 may be outboard of the housing 128. However, the mounting holes 184 aligned with the idler-level bores 160 and the mounting holes 184 outboard of the pump/motor 112 may be spaced an equal distance from the longitudinal axis 162 of the drive shaft 140.

Aside from the mounting holes 184, one or more of the plurality of fastener receiving openings may be blind openings that extend into the pump/motor surface of the flange, but do not extend fully through the flange. These openings may be adapted to receive fasteners to secure the pump/motor 112 to the flange 118. As shown, in FIGS. 3 and 5, for example, one or more blind openings 186 may be provided on the pump/motor surface 172 of the flange 118 that are aligned with the drive-level bores 158 of the pump/motor 112. As shown in FIG. 3, the blind openings 186 and the mounting holes 184 aligned with the idler-level bores 160 of the pump/motor 112 may be equidistance from the centerline of the pump/motor 112.

As mentioned, the drive-level bores 158 of the pump/motor 112 and the idler-level bores 160 of the pump/motor 112 may be spaced along the Y-axis an equal distance from the centerline of the pump/motor and the drive shaft 140 of the pump 112 may be offset along the Y-axis from the centerline 150 of the pump/motor 112 by an offset distance (Δ). Moreover, the drive-level bores 158 of the pump/motor may be spaced from the drive shaft along the Y-axis by a distance of ½P_{g}−Δ and the idler-level bores 160 of the pump/motor may be spaced from the drive shaft along the Y-axis by a distance of ½P_{g}+Δ. In view of this pump/motor geometry, the mounting holes 184 in the flange may be arranged accordingly. That is, the mounting holes 184 that are aligned with the idler-level bores 160 in the pump/motor 112 may be spaced from the drive shaft opening 168 along the Y-axis by a distance of ½P_{g}+Δ. Moreover, the mounting holes 184 in the flange 118 that are outboard of the housing 128 may also be spaced from the drive shaft opening 168 along the Y-axis by a distance of ½P_{g}+Δ. The blind holes 186 in the flange that are aligned with the drive-level bores 158 of the pump/motor 112 may be spaced from the drive shaft opening 168 along the Y-axis by a distance of ½P_{g}−Δ. The lateral spacing (e.g., along the X-axis) of the mounting holes 184 in the flange 118 may match the lateral spacing of the assembly bores of the pump/motor.

It is to be appreciated that the particular arrangement and spacing of the mounting holes allows for mounting the pump/motor using a relatively large bolt circle (e.g., 110 mm diameter) while also accommodating a relatively small available area on the mounting location. Still further, the spacing allows for avoiding an overhang of the flange beyond the mount location area. The combination of these (e.g., relatively large bolt circle and small space claim) provides for a high amount of torque transfer without interfering with surrounding parts/pieces and without demanding a large space claim in an engine compartment.

In a particular example, as shown in FIG. 6A, the flange 118 may include four mounting holes arranged in a generally rectangular pattern. The spacing of the openings along the X-axis (e.g., the X-dimension) may range from approximately 45 mm to approximately 75 mm, or from approximately 55 mm to approximately 65 mm or an X-dimension of approximately 60 mm may be provided. The spacing of the openings along the Y-axis (e.g., the Y-dimension) may range from approximately 70 mm to approximately 110 mm, or from approximately 80 mm to approximately 100 mm, or a Y-dimension of approximately 90-95 mm or approximately 92.2 mm may be provided. In one or more examples, the plurality of mounting holes may all be equidistant to the drive shaft or the Z-axis. That is, for example, the plurality of mounting holes may all fall on the same bolt circle defined by a radius having the Z-axis as its center point. In one or more examples, the radius may range from approximately 40 mm to approximately 70 mm or from approximately 50 mm to approximately 60 mm or a radius of approximately 55 mm may be provided. A corresponding bolt circle dimension may include the above range values multiplied by 2 (e.g., 55 mm radius=110 mm bolt circle).

With these mounting hole dimensions, it is noted that the ratio of the pilot projection to the X-dimension of the flange may range from approximately 0.8 to 2.2, or from approximately 1.0 to 1.8, or from approximately 1.3 to 1.5, or a ratio of approximately 1.5 may be provided. In addition, the ratio of the pilot projection to the Y-dimension of the flange may range from approximately 0.5 to 1.4, or from approximately 0.7 to 1.1, or a ratio of approximately 0.9 may be provided. Still further the ratio of the pilot projection to the bolt circle may range from approximately 0.4 to 1.3 or from approximately 0.65 to approximately 0.85, or a ratio of approximately 0.75 may be provided. Still further, the ratio of the bolt circle to the pump/motor width may range from approximately 0.8 to 1.9, or from approximately 1.1 to 1.5, or a ratio of approximately 1.3 may be provided. With respect to this last ratio, the inventors here have managed to provide a bolt circle larger than the width of the pump/motor without extending the flange and mounting holes beyond the boundary of the pump/motor in more than one direction. Accordingly, the torque capacity of the connection is significant while, at the same time, accommodating the space constraints of the mounting location and avoiding overhanging flanges, mounting location modifications, equipment interference and the like.

It is to be appreciated that since 3 of the sides of the flange 118 generally align with the sides 152 of the housing 128 and only a single 4^{th} sides extends beyond the housing, 2 of the 4 mounting holes in the flange 118 may fall within the footprint of the housing 128. In one or more examples, one or more of the holes may, nonetheless, be used to secure the pump/motor 112 to the mounting location 116 (e.g., one or more of the mounting holes that align with the idler-level bores 160 in the pump/motor 112). For example, the pump/motor 112 may be assembled with 3 assembly bolts instead of 4, leaving the 4^{th} assembly bore in the pump/motor available for an additional bolt. The pump/motor 112 may be secured to the pump/motor surface 172 of the flange 118 using the 3 assembly bolts. For example, two of the assembly bolts may be secured to the blind holes 186 on the pump/motor surface 172 of the flange 118. The 3^{rd} of the 3 assembly bolts may be secured to one of the mounting holes in the flange 118 as shown in FIG. 4 (e.g., bottom right opening). It is noted that in this case, the mounting hole may, instead, be a blind hole on the pump/motor surface 172. The pump/motor 112 and flange 118 may then be secured to the mounting location using 3 mounting bolts where 2 of the mounting bolts are placed through the flange 118 and into the mounting location 116 (e.g., upper 2 openings in FIGS. 4) and 1 of the mounting bolts may be placed through the pump/motor 112, through the flange 118, and into the mounting location 116 (e.g., lower left opening in FIG. 4). Where 3 mounting bolts are used, it is to be appreciated that whether the bottom left or bottom right mounting hole 184 in the flange 118 is used may depend on the rotational direction of the pump/motor 112. For example, if clockwise rotation of the pump/motor is used, one of the lower holes 184 may be used and if counterclockwise rotation of the pump/motor is used, the other of the lower holes 184 may be used. Which ever hole 184 is used for securing the flange 118 to the mounting location 116, the other of the holes 184 may be used for securing the pump/motor to the flange 118 and may be a through hole or a blind hole. It is to be further appreciated, that 4 mounting bolts may also be used. In this case, the supplier may provide 2 assembly bolts leaving two bores in the pump/motor 112 available for mounting bolts. Alternatively, the pump/motor manufacturer may provide 4 assembly bolts where the bottom 2 assembly bolts are later used as mounting bolts or are replaced with mounting bolts when mounting the pump/motor and flange to the mounting location.

### INDUSTRIAL APPLICABILITY

Several advantages of the above-described design give rise to its industrial applicability. For example, the particular arrangement of the mounting openings in the flange, particularly that one or more of the openings is within the footprint boundary of the pump/motor allows for using an increased number of bolts to secure the pump/motor to the mounting location without expanding the flange size. This allows for a stronger connection without interference where the flange would otherwise extend beyond the mounting location boundary. This also avoids needing to adjust the mounting location geometry because the flange size remains within the mounting location boundary. Still further, the present design avoids interfering with side porting of the pump/motor. The relatively large pilot dimension provides for the opportunity to install a large bearing in the mating component (e.g., at the mounting location). This also provides for a larger through flange suction portion and can provide for an O-ring seal in the pilot.

The above detailed description is intended to be illustrative, and not restrictive. The scope of the disclosure should, therefore, be determined with references to the appended claims, along with the full scope of equivalents to which such claims are entitled.

What is claimed is:

1. A pump/motor and flange for mounting the pump/motor at a mounting location, comprising:
a pump/motor comprising:
a housing defining a connection end and a free end and defining a cavity containing operable components of the pump/motor, the housing having a longitudinal centerline and including a drive-level bore and an idler-level bore, wherein:
each of the drive-level bore and the idler-level bore:
are adapted to receive a fastener;
are equally spaced, in opposite directions, away from the longitudinal centerline; and
extend parallel to the longitudinal centerline, and
the drive-level bore is spaced apart from the idler-level bore by a pump/motor gauge distance; and
a drive shaft extending from within the cavity out of the connection end of the housing, the drive shaft having a longitudinal or Z-axis parallel to the longitudinal centerline of the housing and being offset from the longitudinal centerline by an offset distance measured in a direction extending toward the drive-level bore and parallel to a Y-axis that is perpendicular to the Z-axis; and
a flange having a mounting surface and a pump/motor surface and comprising a drive shaft opening configured to receive the drive shaft, a first mounting hole for securing the flange to the mounting location, the first mounting hole being spaced downward from the drive shaft opening by a first distance parallel to the Y-axis and equal to ½ the pump gauge distance plus the offset distance and a second mounting hole for securing the flange to the mounting location, the second mounting hole being spaced upward from the drive shaft opening by a second distance equal to the first distance.

2. The pump/motor and flange of claim 1, wherein the first mounting hole is aligned with the idler-level bore of the pump/motor.

3. The pump/motor and flange of claim 1, wherein the flange further comprises a blind hole spaced upward from the drive shaft opening by a third distance equal to ½ the pump/motor gauge distance minus the offset distance.

4. The pump/motor and flange of claim 2, wherein the blind hole is aligned with the drive-level bore of the pump/motor.

5. The pump/motor and flange of claim 1, wherein the pump/motor and flange are mounted to a mounting location.

6. The pump/motor and flange of claim 5, further comprising a mounting bolt extending through the idler-level bore, through the first mounting hole and securing the flange to the mounting location.

7. The pump/motor and flange of claim 5, wherein the idler-level bore comprises two idler-level bores spaced laterally from one another along an X-axis perpendicular to the Z-axis and the Y-axis.

8. The pump/motor and flange of claim 7, wherein the first mounting hole comprises two mounting holes each aligned with respective ones of the two idler-level bores.

9. The pump/motor and flange of claim 8, further comprising a mounting bolt extending through one of the two idler-level bores, through the respective first mounting hole, and securing the flange to the mounting location.

10. The pump/motor and flange of claim 9, further comprising an assembly bolt extending through the other of the two idler level bores and stopping in the respective first mounting hole.

11. The pump/motor and flange of claim 5, further comprising a mounting bolt extending through the second mounting hole and securing the flange to the mounting location.

12. A pump/motor and flange for mounting the pump/motor at a mounting location, comprising:
a pump/motor having a housing defining a free end and a connection end defining a connection footprint, the pump/motor having a drive shaft extending out of the connection end and being offset from a centerline of the pump/motor;
a flange having a mounting surface and a pump/motor surface and comprising a drive shaft opening generally centered on the flange and configured to receive the drive shaft such that the connection footprint of the pump/motor is offset from a centered position on the pump/motor surface, the flange having:
a first mounting hole for securing the flange to the mounting location and being arranged within the connection footprint; and
a second mounting hole for securing the flange to the mounting location and being arranged outside the connection footprint.

13. The pump/motor and flange of claim 12, wherein the first mounting hole comprises two mounting holes spaced laterally from one another by an X-dimension.

14. The pump/motor and flange of claim 13, wherein the second mounting hole comprises two mounting holes spaced laterally from one another by the X-dimension.

15. The pump/motor and flange of claim 14, wherein the first two mounting holes and the second two mounting holes are spaced vertically from one another by a Y-dimension.

16. The pump/motor and flange of claim 15, wherein the first two mounting holes and the second two mounting holes are all equidistant from the drive shaft opening.

17. The pump/motor and flange of claim 15, wherein the X-dimension is approximately 60 mm and the Y-dimension is approximately 92.2 mm.

18. The pump/motor and flange of claim 12, further comprising an additional pump/motor where the mounting location is the additional pump/motor.

19. The pump/motor and flange of claim 12, further comprising an additional pump/motor mounted to the free end of the pump/motor.

20. A flange for mounting a pump/motor to a mounting location where the pump/motor has a longitudinal centerline and includes a first bore and a second bore for receiving fasteners, the first and second bore being parallel to the longitudinal centerline, equally spaced, in opposite directions, away from a longitudinal centerline, and spaced from one another by a pump/motor gauge distance, and the pump/motor also has a drive shaft parallel to and offset from the longitudinal centerline by an offset distance, the flange comprising:
a body comprising a generally plate-like element having a mounting surface and an opposing pump/motor surface;
a drive shaft receiving opening extending through the body and defining a relative position for mounting the pump/motor to the flange;
a first mounting hole for securing the flange to the mounting location, the first mounting hole being spaced downward from the drive shaft opening by a first distance equal to ½ the pump/motor gauge distance plus the offset distance and a second mounting hole for securing the flange to the mounting location, the second mounting hole being spaced upward from the drive shaft opening by a second distance equal to the first distance.

21. The flange of claim 20, further comprising a pilot projection.

22. The flange of claim 21, wherein the pilot projection has a diameter ranging from approximately 80 mm to 85 mm.

23. The flange of claim 22, wherein the pilot projection has a diameter of approximately 81.5 mm.
